(19) United States
(12) Patent Application Publication
(10) Pub. No.: US 2014/0289369 A1
(43) Pub. Date: Sep. 25, 2014

(54) CLOUD-BASED SYSTEM FOR FLASH CONTENT STREAMING

(71) Applicants: Sheng Yang, Beijing (CN); Ping-kang Hsuing, Pacific Palisades, CA (US)

(72) Inventors: Sheng Yang, Beijing (CN); Ping-kang Hsuing, Pacific Palisades, CA (US)

(21) Appl. No.: 14/065,414

(22) Filed: Oct. 28, 2013

Related U.S. Application Data
(60) Provisional application No. 61/719,331, filed on Oct. 26, 2012.

(51) Int. Cl. H04L 29/06

(52) U.S. Cl. CPC H04L 65/607
USPC 709/219

(57) ABSTRACT

A cloud-based system executes a rich Internet application such as a Flash application and compresses its video stream output. A player executes a rich Internet application and produces frames of a video stream according to the rich Internet application and inputs received from a remote user. An analyzer predicts a frame being generated by the rich Internet application player, based on prior frames and prior user inputs. It also generates a set of side information comprising motion compensation data. A combiner combines the side information with a previously encoded frame to produce a reference frame. A comparator generates a residual frame from a comparison of the reference frame with the frame generated by the player. A compressor compresses the residual frame using standard compression techniques. An Internet transmitter transmits the compressed residual frame to the remote user using a UDP connection and transmits the side information using a TCP connection.

### CROSS-REFERENCE TO RELATED APPLICATION(S)

This application claims priority to and the benefit of U.S. Patent Application No. 61/719,331, filed on Oct. 26, 2012, the entire content of which is incorporated herein by reference.

### BACKGROUND

Computer games, particularly Flash games, have become one of the most important sectors in online entertainment. However, some devices, notably Apple's iPhone and iPad, do not support Flash and cannot run Flash games or other Flash content. One approach to providing Flash games on mobile devices is to stream the output of a remote Flash player as traditional video content (ordered sequences of individual still images). The idea is to define a client-server architecture where modern video streaming and cloud computing techniques are exploited to allow client devices without Flash capability to provide their users with interactive visualization of Flash games and other content.

More specifically, the concept of cloud-based on-line Flash gaming is to shift the Flash playing operations from the local client to the server in the cloud center and stream the rendered Flash contents to end users in form of video, so that even platforms without Flash support can run Flash games. Such services have been offered by vendors such as iSwifter. The new service heavily relies on low-latency video streaming technologies. It demands rich interactivity between clients and servers and low delay video transmission from the server to the client. Many technical issues for such a system were discussed by Tzruya et al., in “Games@Large—a new platform for ubiquitous gaming and multimedia”, Proceedings of BBEurope, Geneva, Switzerland, December 2006, and by A. Jurgelionis et al., in “Platform for Distributed 3D Gaming”, International Journal of Computer Games Technology”, 2009, both of which is also incorporated by reference as if set forth in full herein. It remains needed, however, to develop highly efficient encoding schemes that much higher compression ratios to reduce potential transmission latency.

Conventional video compression methods are based on reducing the redundant and perceptually irrelevant information of video sequences (an ordered series of still images).

Redundancies can be removed such that the original video sequence can be recreated exactly (lossless compression). The redundancies can be categorized into three main classifications: spatial, temporal, and spectral redundancies. Spatial redundancy refers to the correlation among neighboring pixels. Temporal redundancy means that the same object or objects appear in the two or more different still images within the video sequence. Temporal redundancy is often described in terms of motion-compensation data. Spectral redundancy addresses the correlation among the different color components of the same image.

Usually, however, sufficient compression cannot be achieved simply by reducing or eliminating the redundancy in a video sequence. Thus, video encoders generally must also discard some non-redundant information. When doing this, the encoders take into account the properties of the human visual system and strive to discard information that is least important for the subjective quality of the image (i.e., perceptually irrelevant or less relevant information). As with reducing redundancies, discarding perceptually irrelevant information is also mainly performed with respect to spatial, temporal, and spectral information in the video sequence.

The reduction of redundancies and perceptually irrelevant information typically involves the creation of various compression parameters and coefficients. These often have their own redundancies and thus the size of the encoded bit stream can be reduced further by means of efficient lossless coding of these compression parameters and coefficients. The main technique is the use of variable-length codes.

Video compression methods typically differentiate images that can or cannot use temporal redundancy reduction. Compressed images that do not use temporal redundancy reduction methods are usually called INTRA or I-frames, whereas temporally predicted images are called INTER or P frames. In the INTER frame case, the predicted (motion-compensated) image is rarely sufficiently precise, and therefore a spatially compressed prediction error image is also associated with each INTER frame.

In video coding, there is always a trade-off between bit rate and quality. Some image sequences may be harder to compress than others due to rapid motion or complex texture, for example. In order to meet a constant bit-rate target, the video encoder controls the frame rate as well as the quality of images. The more difficult the image is to compress, the worse the image quality. If variable bit rate is allowed, the encoder can maintain a standard video quality, but the bit rate typically fluctuates greatly.

H.264/AVC (Advanced Video Coding) is a standard for video compression. The final drafting work on the first version of the standard was completed in May 2003 (Joint Video Team of ITU-T and ISO/IEC JTC 1, Draft ITU-T Recommendation and Final Draft International Standard of Joint Video Specification (ITU-T Rec. H.264|ISO/IEC 14496-10 AVC), Doc. JVT-G050, March 2003) and is incorporated by reference as if set forth in full herein. H.264/AVC was developed by the ITU-T Video Coding Experts Group (VCEG) together with the ISO/IEC Moving Picture Experts Group (MPEG). It was the product of a partnership effort known as the Joint Video Team (JVT). The ITU-T H.264 standard and the ISO/IEC MPEG-4 Part 10 (AVC) standard are jointly maintained so that they have identical technical content. H.264/AVC is used in such applications as players for Blu-ray Discs, videos from YouTube and the iTunes Store, web software such as the Adobe Flash Player and Microsoft Silverlight, broadcast services for DVB and SBTVD, direct-broadcast satellite television services, cable television services, and real-time videoconferencing.

The coding structure of H.264/AVC is depicted in FIG. 1, in which each coded picture is represented in block-shaped units of associated luma and chroma samples called macroblocks. The basic video sequence coding algorithm is a hybrid of inter-picture prediction to exploit temporal statistical dependencies and transform coding of the prediction residual to exploit spatial statistical dependencies. H.264 improves the rate distortion performance by exploiting advanced video coding technologies, such as variable block size motion estimation, multiple reference prediction, spatial prediction in intra coding, context based variable length coding (CAVLC), and context-based adaptive binary arithmetic coding (CABAC).

The H.264/AVC standard is actually more of a decoder standard than an encoder standard. This is because while H.264/AVC defines many different encoding techniques which may be combined together in a vast number of permutations and each technique having numerous customizations, an H.264/AVC encoder is not required to use any of them or use any particular customizations. Rather, the H.264/AVC standard specifies that an H.264/AVC decoder must be able to decode any compressed video that was compressed according to any of the H.264/AVC defined compression techniques.

Along these lines, H.264/AVC defines 17 sets of capabilities, which are referred to as profiles, targeting specific classes of applications. The Extended Profile (XP), depicted in FIG. 2, is intended as the streaming video profile and accordingly provides some additional tools to allow robust data transmission and server stream switching.

Flash players operate on files in the SWF file format. The SWF file format was designed from the ground up to deliver graphics and animation over the Internet. The SWF file format was designed as a very efficient delivery format and not as a format for exchanging graphics between graphics editors. See, Adobe, “SWF File Format Specification, Version 10,” which is incorporated by reference as if set forth in full herein. It was designed to meet the following goals:

On-screen Display—The format is primarily intended for on-screen display and so it supports anti-aliasing, fast rendering to a bitmap of any color format, animation and interactive buttons.

Extensibility—The format is a tagged format, so the format can be evolved with new features while maintaining backwards compatibility with older players.

Network Delivery—The files can be delivered over a network with limited and unpredictable bandwidth. The files are compressed to be small and support incremental rendering through streaming.

Simplicity—The format is simple so that the player is small and easily ported. Also, the player depends upon only a very limited set of operating system functionality.

File Independence—Files can be displayed without any dependence on external resources such as fonts.

Scalability—Different computers have different monitor resolutions and bit depths. Files work well on limited hardware, while taking advantage of more expensive hardware when it is available.

Speed—The files are designed to be rendered at a high quality very quickly.

The SWF file structure is shown in FIG. 3. A SWF file is composed a series of tags. Each tag corresponds to a symbol and can be retrieved independently. The symbols are put together according to certain rules, so as to construct a frame (image). The rules are usually given by ActionScript. In other words, a Flash player uses the ActionScript to determine how to put together the various symbols to produce the various frames that make up the Flash content. The ActionScript also includes how to modify how the Flash player puts together the symbols based on user inputs or other external data. In this manner, Flash content can consist of games.

### SUMMARY

In various of the embodiments, focus is on the adjustment of the H.264/AVC coding scheme so as to provide higher coding gain at the server end and optimize the encoder for the best performance in terms of computational cost, error resilience, and compression efficiency. The H.264/AVC video coding standard is used as the basis and numerous fine-tuning are made so that it can meet the stringent needs of the real-time on-line gaming requirement.

In various of the embodiments, the system includes two key modules: a high efficient video compression scheme specifically designed for Flash content, and a two-layer network scheme. The former encodes Flash-based video sequences by leveraging side information, so as to achieve significantly higher coding gain than standard video compression algorithms. The latter is in charge of data transmission.

### BRIEF DESCRIPTION OF THE DRAWINGS

FIG. 1 is a diagram showing the structure of H.264/AVC video encoding.

FIG. 2 is a diagram of Available coding tools in different profiles for H.264/AVC codecs.

FIG. 3 is a block diagram depicting the SWF file structure.

FIG. 4 is a block diagram of the system architecture of cloud-based platform for Flash content.

FIG. 5 is a block diagram depicting the architecture of a standard video encoder.

FIG. 6 is a block diagram depicting the Architecture of a Flash-based video encoder.

FIG. 7 is a block diagram depicting the Architecture of a Flash-based video encoder incorporating standard video encoder.

FIG. 8 is a block diagram depicting the Network architecture and data flow of a Flash-based video streaming system, where RTT is the round trip delay and p is the packet loss rate.

FIG. 9 shows the bitrate comparison of two encoders when QP=10.

FIG. 10 shows the cumulative bit comparison of two encoders when QP=10.

FIG. 11 is a partial enlarged drawing of FIG. 9.

FIG. 12 shows the bitrate comparison of two encoders when QP=20.

FIG. 13 shows the cumulative bit comparison of two encoders when QP=20.

FIG. 14 is a partial enlarged drawing of FIG. 12.

FIG. 15 shows the PSNR comparison of two encoders.

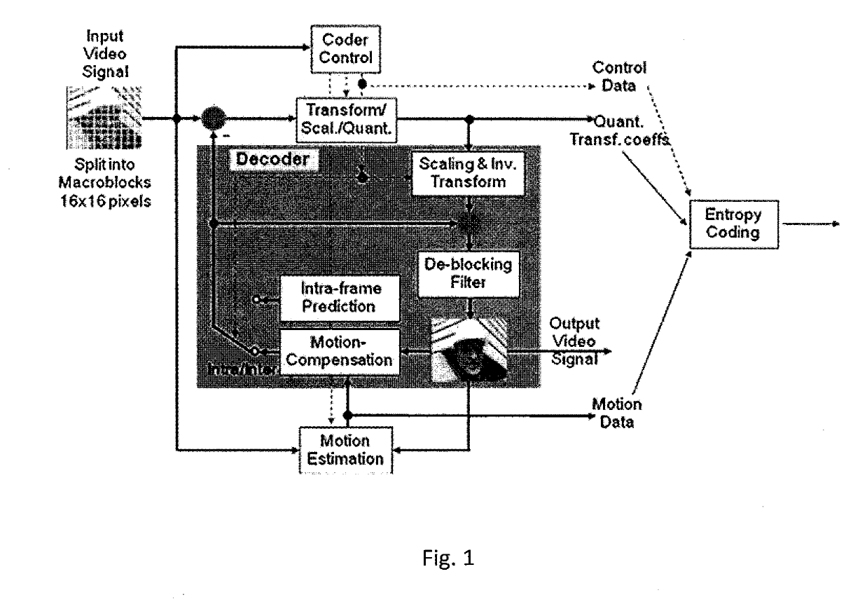

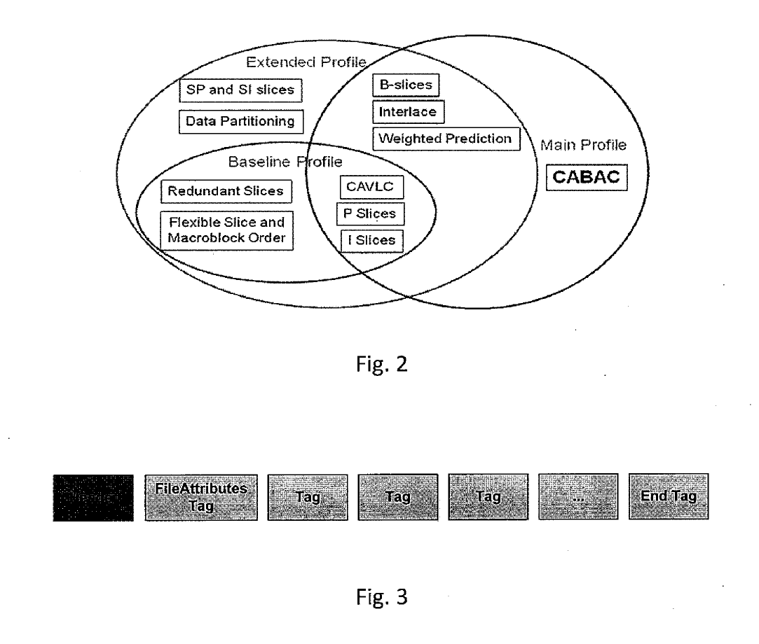

### DETAILED DESCRIPTION

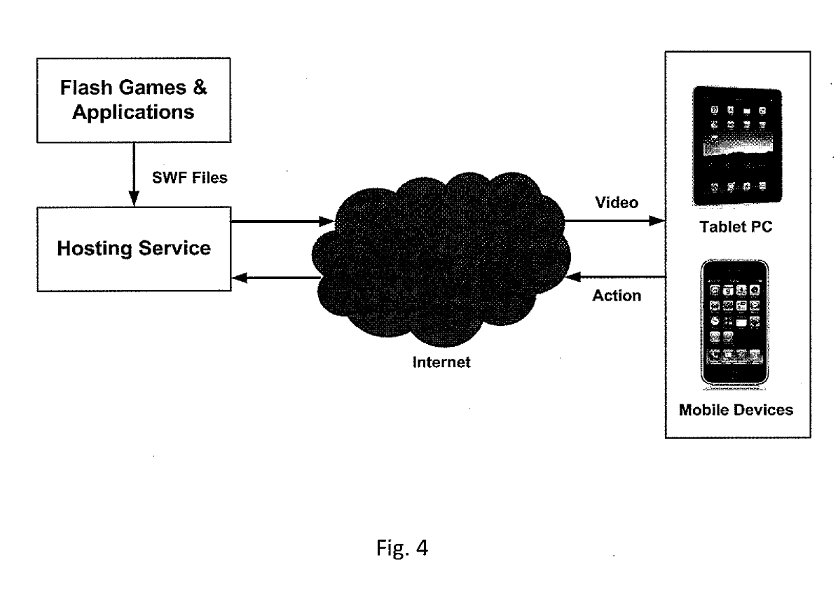

The system architecture of a cloud-based platform for delivering Flash content is illustrated in FIG. 4. The Flash games and applications (SWF files) are stored and managed on the server side. A hosting service includes a number of instances of a Flash player, each executing a SWF file for a different user. Users send Flash content requests and interactive commands to the hosting service via a network, such as the Internet. When a Flash content request is received by the hosting service, it begins an instance of a Flash player and supplies it with the appropriate SWF file. This Flash player instance then produces rendered Flash content (as video frames), which is compressed and delivered to the user. This Flash player instance also deals with the user commands and continues to deliver the resulting compressed Flash video back to the user.

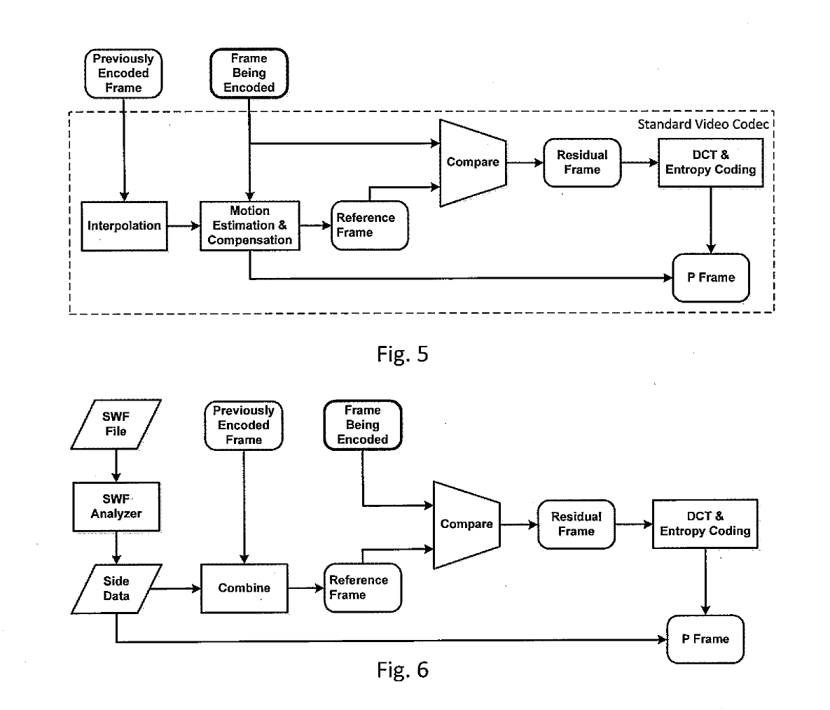

A block diagram depicting the standard video compression algorithm is shown in FIG. 5. As mentioned above, one component of video compression is reducing the temporal redundancy between frames. When a frame is being coded as a P frame, it is compared to another, previously encoded frame, such as an I frame, to estimate the motion between the two frames (motion estimation) and motion compensation data is generated. Often, this other, previously encoded frame precedes the frame being encoded in the video stream, but this is not always the case. Also, in some cases, more than one previously encoded frame is used to generate motion compensation data. For example, encoded frames called B frames typically have at least two “other, previously encoded” frames with one of these frames following the frame being encoded in the video stream. The following discussion describes an example in which only one “other, previously encoded” frame is used to create motion compensation data, but the present invention can be equally be applied to situations in which more than one “other, previously encoded” frames is used to create motion compensation data.

Motion compensation data generally includes a number of motion vectors and references to the portions of the frame (up to the entire frame) to which the motion vectors apply.

Motion compensation data often can be used to represent most of the differences between the other, previously encoded frame. However, in almost all cases, motion compensation data alone is not enough to recreate the frame being encoded from the other, previously encoded frame. Accordingly, a reference frame is typically reconstructed using the other, previously encoded frame and the motion compensation data. The frame being coded is then compared with the this reference frame to determine the difference between them (the portion of the frame being encoded that is not recreated from the combination of the other, previously encoded frame and the motion compensation data). Then only this difference, also known as a residual frame, is calculated for coding—rather than having to code the entire difference between the frame being coded and the other, previously encoded frame, which is usually much bigger than the combination of the motion compensation data and the residual frame.

A block diagram depicting the architecture of many embodiments of the present Flash-based video compression system is illustrated in FIG. 6. The major difference between standard video codecs and these embodiments is in how the reference frame is reconstructed.

As shown in FIG. 6, the SWF file is parsed by the SWF analyzer module. The SWF analyzer mimics a Flash player and, based on prior frames and user inputs, predicts the frame that will be generated by the Flash player instance actually executing the SWF file for the user. As the predicted frame is composed of various combinations of parts of objects in the SWF file and the movements described in the ActionScript, the predicted frame primarily consists of motion compensation data derived from these movements and an identification of the previously encoded frame from which the motion compensation data was generated. The motion compensation data generated by the SWF analyzer module is referred to as side information (side info). The side information, without any residual data, is used to reconstruct the reference frame, together with the previously encoded frame. If every operation defined by ActionScript of the SWF file is accurately duplicated by the SWF analyzer, the reference frame will be very similar to the frame being coded, if not exactly same.

In some cases, however, for several different reasons, the combination of the side information and the previously encoded frame will not be an exact match of the frame being encoded. For this reason, the side information based reference frame is still compared with the frame being encoded as is done in standard video compression and any differences are encoded as a residual frame. Of course, if the side information based reference frame is identical to the frame being encoded, the residual frame will be blank. Even if the side information based reference frame is not identical to the frame being encoded, it is usually much closer to frame being decoder, resulting in a much less complex residual frame that can be much more highly compressed than the standard residual frame can be.

One reason that reference frame made from the side information and the previously encoded frame may not be an exact match for the frame being decoded is subtle differences between the way the SWF analyzer executes one or a combination of ActionScript operations compared to an actual Flash player instance. Another reason is that the hardware capability on client side (ability to process all of the side information in real-time) may force a limitation on the percentage of ActionScript operations that can be executed by the SWF analyzer and thus encoded as side information. In such cases, the more operations are executed by the SWF analyzer, the more accurate the reference frame is, at the cost of requiring the more computational power on the client side.

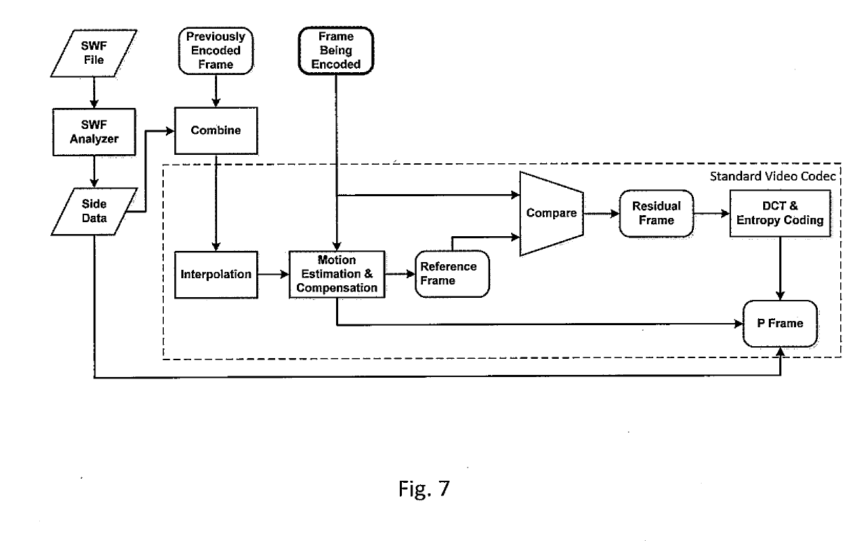

In many embodiments, the SWF analyzer is used in combination with a standard video codec, as shown in FIG. 7. In these embodiments, rather than using the combination of the side information and the previously encoded frame to reconstruct the reference frame directly, the combination of the side information and the previously encoded frame is fed into a standard video codec where the combination is interpolated and motion estimation is performed for the frame being encoded based on the interpolation results. Typically, there will be little if any motion detected in the motion estimation and thus the motion compensation data will be very small if not empty. The reference frame is then created based on this motion compensation data and the combination of the previously encoded frame with the side information and the compression continues as described in the embodiments discussed in reference to FIG. 6.

One advantage of the embodiments described with reference to FIG. 7 is that it can be used with a standard video codec. More particularly, these embodiments are easy to be integrated into standard video compression framework, since the side information can be considered as a pre-processing module to improve the accuracy of motion estimation and compensation, just like some useful functions (for example, interpolation and filtering) that have already been adopted in standard video codecs. A corresponding disadvantage is that some slight inefficiencies may be introduced, both in terms of encoding speed and the degree of compression, due to addition of the extra interpolation and motion estimation processes as compared to embodiments described with reference to FIG. 6.

The SWF analyzer allows the reference frame can be more accurately reconstructed and the frame being encoded can be compressed more efficiently. The main aspects of the compression/decompression process involving the SWF analyzer are described as follows:

1. Analyze the Flash file to be compressed.

2. Locate the objects in the Flash file that impose the larger impact on compression and pay special attention to them. For example, the larger the objects are and the long the objects last (i.e., the more frames in which the object appears), the more important they are. On the contrary, the objects of smaller impact can be handled by standard methods. According to this, the impact factor of an object can be defined as IF(o)=Area(o)·Frame(o), where IF(o) denotes the impact factor of object o, Area(o) the area of o, and Frame(o) the frames in which o appears.

3. Compress the side information by a lossless method, for example, RLC or other entropy coding methods. The side information cannot be lost, otherwise it will cause terrible artifacts. According to network conditions (congestion, latency, packet loss rate, etc.), it can be determined whether to use error resilience or not.

4. Compress the objects (either still image or video) separately.

5. After receiving the objects and the side information, client first reconstructs the reference frames before motion estimation and then renders the current frame.

By the above five steps, the side information assisted video compression method is implemented and it, can dramatically improve the coding gain.

In most embodiments, the Flash video sequences are processed into two types of data: side information and video data. As discussed above, the former imposes a much more significant impact on visual quality than the latter. The loss of even a small portion of side information will usually result in disastrous results, leading to severe damage of a sequence of frames. However, the loss of some video stream packets will only cause minor artifacts, and the video sequences can still be played. Therefore, the side information must be treated differently when delivered via network.

After Flash data is compressed and prioritized, it is ready for streaming to the client. The requirements for game streaming are different from those of video streaming. In video, the data order is known in advance while, in game streaming, the sequence of data to be delivered depends on the user action. Furthermore, video streaming requires time-synchronized data arrival for a smooth viewer experience while game streaming can tolerate some irregular latency in transmission. This allows game streaming to use more flexible transmission and error protection techniques. The proposed transmission scheme, called Interactive Real Time Streaming Protocol (IRTSP), employs a network architecture that facilitates the server-client communication, and takes advantage of the flexibility in data arrival to increase transmission robustness.

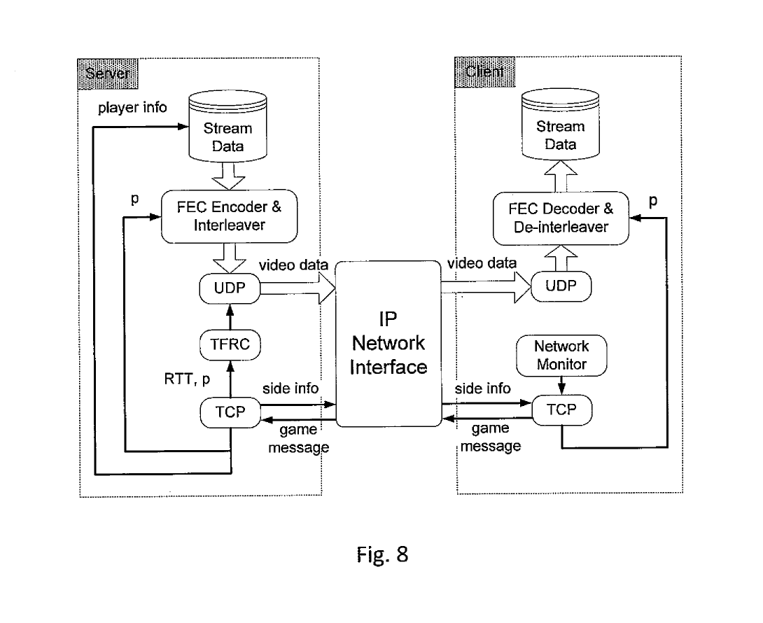

When a user plays online games, the information exchanged between servers and users can be categorized into two types: control messages (including user action and side information) and game data. The former requires two-way communication and relatively little bandwidth. The latter is needed for scene rendering, and is less sensitive to data loss than the former. To facilitate message exchange and data transmission, many embodiments utilize two different types of communication channels. A two-way TCP channel is used for control messages and a one-way UDP channel is used to stream the graphics data. The network architecture is shown in FIG. 8.

The TCP channel provides reliable connections but at the cost of relatively large overhead and potential transmission delays due to retransmission of lost or damaged packets. Due to its potential latency, this channel is suitable for transmitting small and important messages such as the user position and network parameters for which some slight delay can be tolerated. In contrast, the UDP channel offers best effort data transmission that is fast but unreliable. Although packets transmitted via UDP are not guaranteed to arrive at the destination, they can be sent more quickly than by TCP.

The flow of data in these embodiments is illustrated in FIG. 8. As a user plays game, messages are periodically sent to the server over the TCP channel. They are classified and forwarded to corresponding modules for further processing. The transmitted user information is used to generate the video sequences which will be compressed and streamed via the UDP channel. At the same time, the side information for decompression is also transmitted to user via the TCP channel. In most embodiments, the Flash contents is parsed and converted into a deliverable format in advance. Once a user establishes a connection to a server and enters the virtual world, the server will immediately transmit the requested data to the user.

Compared with a wired network, a mobile channel is more hostile due to its lower bandwidth and higher burst error rate. See, M.-T. Sun and A. R. Reibman. “Compressed Video over Networks”, Marcel Dekker, 2000, which is incorporated by reference as if set forth in full herein. Since the compressed video data is transmitted by the UDP protocol, it is more vulnerable to channel errors without special measures. Three techniques are implemented in many embodiments to protect data from being corrupted: Forward Error Correction (FEC), interleaving, and Selective Retransmission Request (SRR).

FEC techniques have been widely used in channel coding and error control. In many embodiments the Reed-Solomon code (see, R. E. Blahut. Theory and Practice of Error Control Codes. Addison-Wesley, Reading, Mass., 1983, which is incorporated by reference as if set forth in full herein) is used, which protects data by adding redundancy.

For a redundancy rate r in the R-S code, lost packets are recoverable only when the network packet loss rate p satisfies the following condition:

$$p \leq \frac{r}{2} .$$

The redundancy rate can be adjusted according to the loss rate feedback.

The purpose of interleaving is to spread the error burst, often happening in wireless channels. When a block is delivered, either it is transmitted error-free and added redundancy is wasted, or it is attacked by the burst error in which case the error correction capability is usually exceeded. Interleaving can overcome this drawback by evenly distributing the burst error into several blocks so that every block can be recovered more easily when it is corrupted. See, S. Floyd, M. Handley, J. Padhye, and J. Widmer. “Equation-based congestion control for unicast applications: the extended version”. http://www.aciri.org/tfrc, February 2000, which is incorporated by reference as if set forth in full herein. However, even though interleaving can be easily implemented at a low cost, it suffers from increased delay, depending on the number of interleaved blocks. Fortunately, the additional delay is usually acceptable in graphics streaming.

Even though mesh data is protected by FEC, it is not free from corruption if the error correction capability is exceeded. In this case, users send retransmission requests to the server for lost packets.

Many enhanced features can be easily integrated into the proposed video compression scheme. For example, some embodiments provide for image and video insertion. This function can be easily implemented by treating the image/video as symbols. The spatial and temporal position to insert the image/video can be sent as side information. By this mean, image/video can be easily overlaid on the original Flash video sequences. This feature is very useful to provide advertisement service.

The experimental results of an exemplary embodiment are given in the following figures.

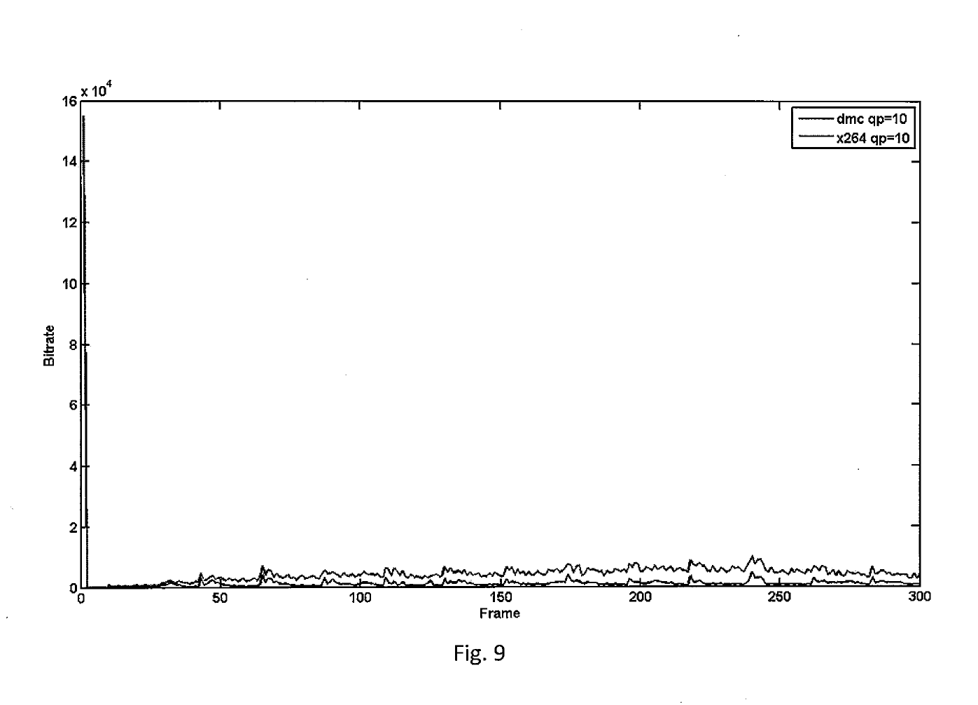

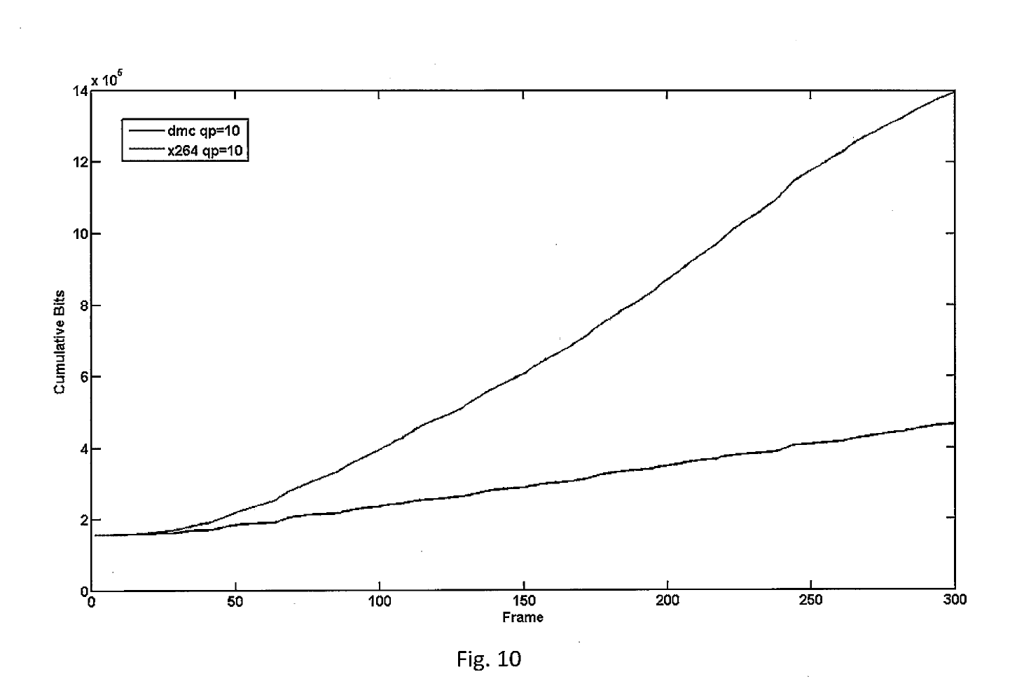

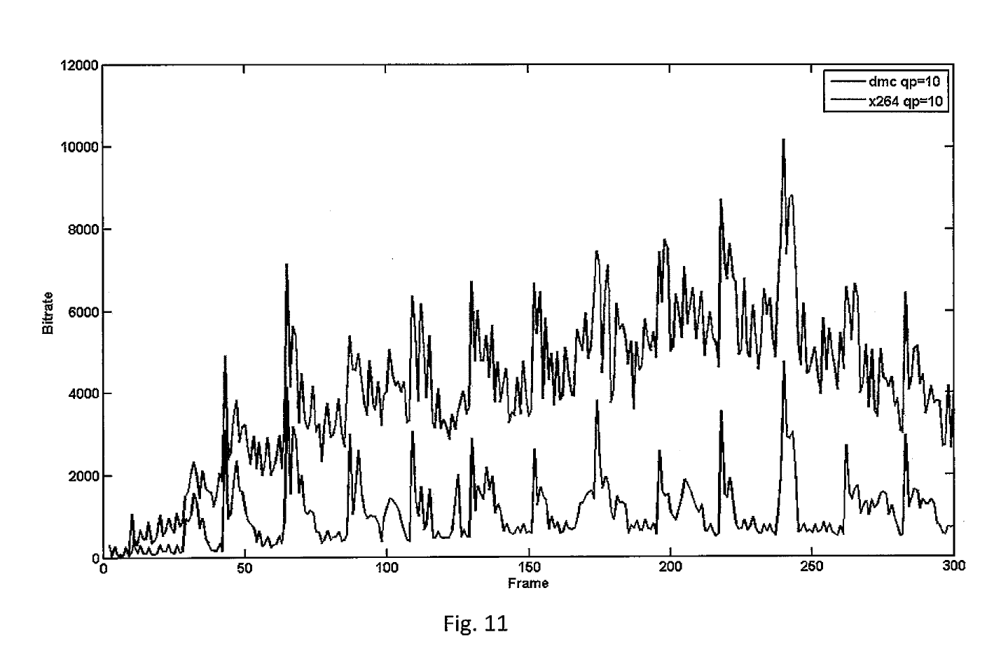

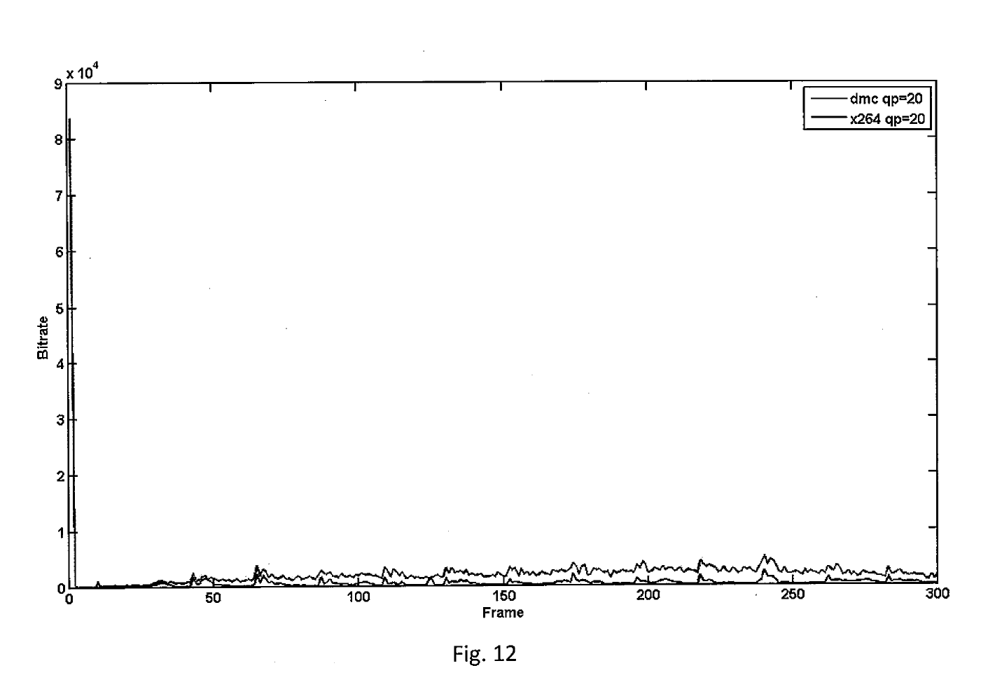

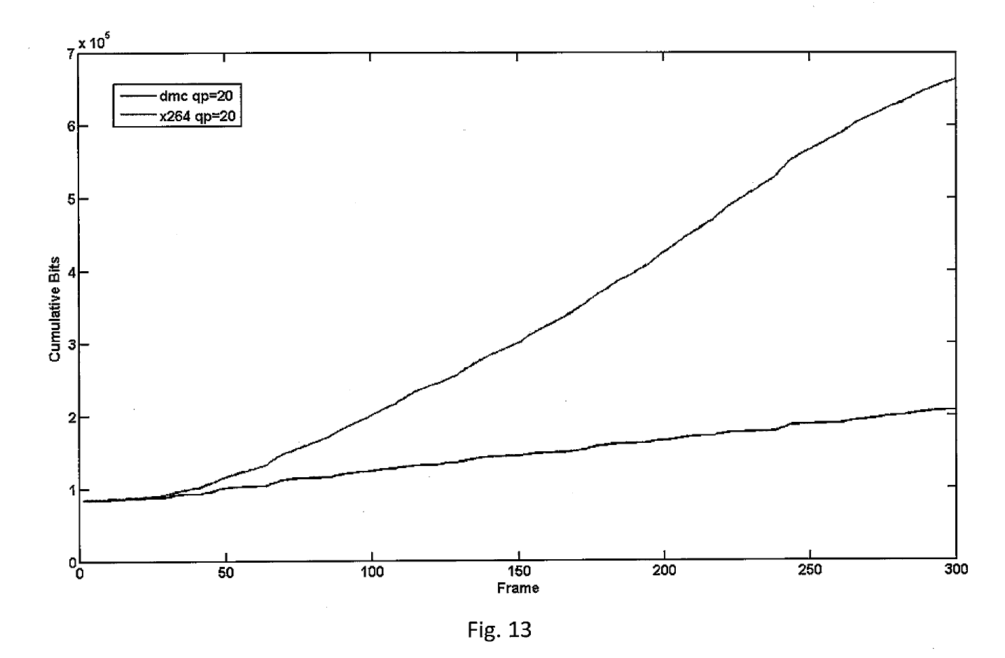

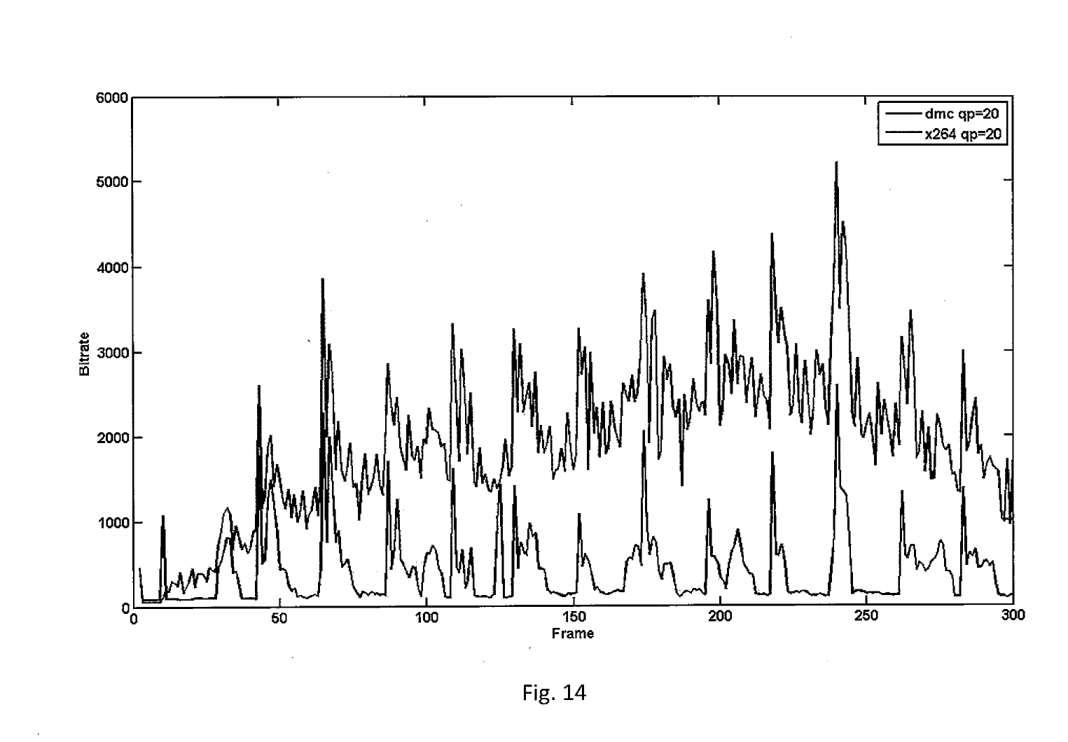

FIG. 9 and FIG. 10 show the bitrate and cumulative bit comparison of the exemplary embodiment and x264 when QP=10. The exemplary embodiment first constructs a reference frame by leveraging the side information extracted from Flash content. By this means, the bitrates can be dramatically reduced. To make FIG. 9 clearer, partial enlarged drawings (skipping the first frame) are given in FIG. 11. The figures when QP=20 are shown in FIG. 12, FIG. 13, and FIG. 14, respectively.

The first frame data is given in Table 1.

TABLE 1
Bits of first frame

| | DMC QP = 10 | DMC QP = 20 | X264 QP = 10 | X264 QP = 20 |
|---|---|---|---|---|
| Bits | 155063 | 83803 | 155030 | 83770 |

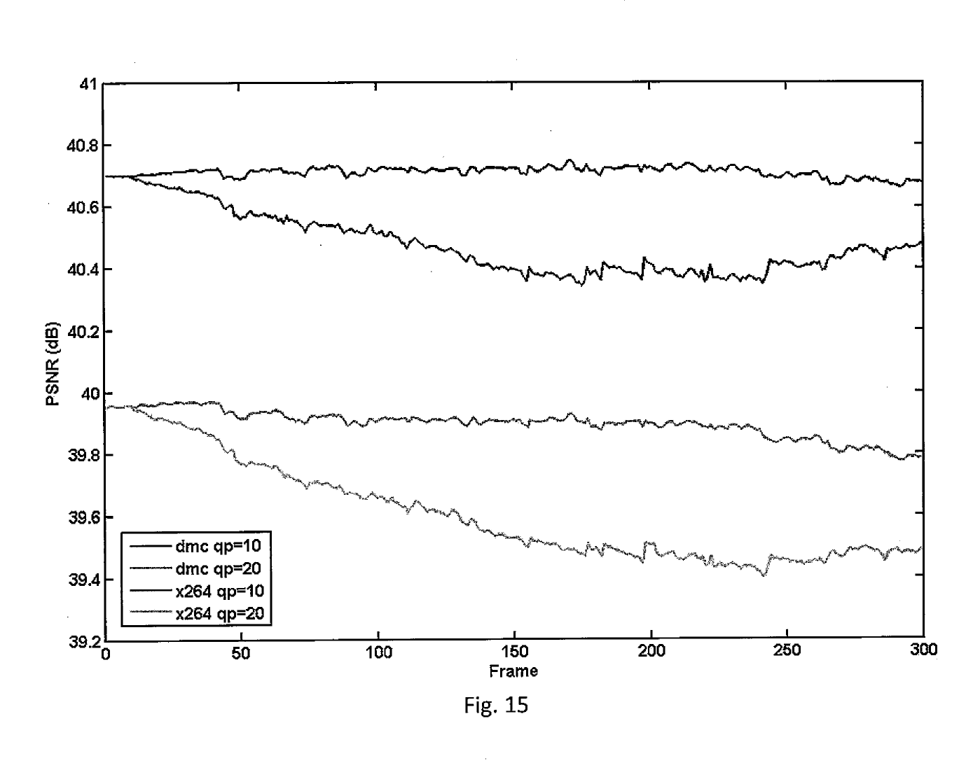

Since all the objects are coded losslessly, it is predictable that the exemplary embodiment will have much better visual quality than x264. The PSNR (Peak Signal-to-Noise Ratio) curves of four cases are illustrated in FIG. 15. From this figure we can see that the exemplary embodiment uses many fewer bits, while achieving better visual quality than x264.

The average bit rate comparison is given in Table 2.

TABLE 2
Average bit rate comparison (bytes)

| | DMC | DMC | X264 | X264 |
|---|---|---|---|---|
| Frames | QP = 10 | QP = 20 | QP = 10 | QP = 20 |
| 1~300 | 1551 | 690 | 4653 | 2211 |
| 1~60 | 3148 | 1716 | 4050 | 2128 |
| 61~300 | 1151 | 434 | 4804 | 2232 |

The above embodiments can be easily applied to Silverlight content.

Microsoft Silverlight is an application framework for writing and running rich Internet applications, with features and purposes similar to those of Adobe Flash. Silverlight integrates multimedia, graphics, animations and interactivity into a single run-time environment. In Silverlight applications, user interfaces are declared in Extensible Application Markup Language (XAML) and programmed using a subset of the .NET Framework. XAML is a markup language and the content described XAML can be more easily been interpreted than Flash.

Here is a typical example of Silverlight XAML file.

<Canvas
xmlns=”http://schemas.microsoft.com/client/2007”
xmlns:x=″http://schemas.microsoft.com/winfx/2006/xaml″>
<Rectangle

Width=″100″
Height=″100″
Fill=″Blue″ />

</Canvas>

It can be easily interpreted to a blue rectangle, with height and width both 100. As a result, the Silverlight contents can be easily separated into background and objects, so that the above embodiments can be easily applied and dramatically improve the coding gain.

In a similar way, the above embodiments may be easily applied to HTML5 content.

Although some embodiments have been disclosed herein, it will be understood by those of ordinary skill in the art that these embodiments are provided by way of illustration only, and that various modifications, changes, alterations, and equivalent embodiments can be made by those of ordinary skill in the art without departing from the spirit and scope of the invention as defined by the following claims.

What is claimed is:

1. A cloud-based system for executing a rich Internet application and compressing its video stream output comprising:
a rich Internet application player, located in the cloud, configured to execute a rich Internet application and produce frames of a video stream according to the rich Internet application and inputs received from a remote user;
a rich Internet application analyzer, located in the cloud, configured to predict, based on prior such frames and prior such user inputs, a frame being generated by the rich Internet application player, and configured to generate a set of side information comprising motion compensation data;
a combiner, located in the cloud, configured to combine the set of side information with a previously encoded frame to produce a reference frame;
a comparator, located in the cloud, configured to generate a residual frame based on a comparison of the reference frame with the frame being generated by the rich Internet application player;
a compressor, located in the cloud, configured to compress the residual frame using standard compression techniques; and
an Internet transmitter configured to transmit the compressed residual frame to the remote user using a UDP connection and transmit the set of side information to the remote user using a TCP connection.

2. The system of claim 1 wherein the rich Internet application player is a Flash player and the rich Internet application is a SWF file.
